(19) United States
(12) Patent Application Publication
(10) Pub. No.: US 2011/0151686 A1
(43) Pub. Date: Jun. 23, 2011

(54) DISTRIBUTOR CONNECTION MODULE

(75) Inventors: Harald Klein, Berlin (DE); Manfred Stockel, Berlin (DE)

(73) Assignee: ADC GmbH, Berlin (DE)

(21) Appl. No.: 13/061,470

(22) PCT Filed: Jul. 23, 2009
(86) PCT No.: PCT/EP09/05354

§ 371 Date: Feb. 28, 2011

(30) Foreign Application Priority Data
Sep. 1, 2008 (DE) 10 2008 045 337.4

(51) Int. Cl. H01R 12/70

(52) U.S. Cl. 439/65

(57) ABSTRACT

The invention relates to a distributor connection module (1) comprising a housing (2) in which at least one printed circuit board (3) with function elements (30) is arranged, input contacts (20) and output contacts (21) for connecting cores, wherein the input and output contacts (20, 21) are accessible from the front (V) of the distributor connection module (1) and are or can be electrically connected to one another by means of the printed circuit board (3), wherein the input and output contacts (20, 21) are arranged on a separate second printed circuit board (6), wherein the separate second printed circuit board (6) has an interface for connection to the first printed circuit board (3) with the function elements (30), which interface is designed in the form of a disconnecting plug (9) with disconnecting contacts (23), wherein electrical connections are fed from the input and output contacts (20, 21) to the disconnecting contacts (23), wherein one input contact (20) is connected to one output contact (21) in each case when the disconnecting contact (23) is closed and, after plugging onto the first printed circuit board (3) with the function elements (30), the input and output contacts (20, 21) are or can be connected together via the function elements (30) when the disconnecting contact (23) is open.

The invention relates to a distributor connection module as claimed in the precharacterizing clause of claim 1.

Distributor connection modules are known for widely differing applications. One application area, for example, is distributors with test access matrix function. Here, for example, the subscriber lines are connected to the input contacts and DSL lines are connected to the output contacts, which are then fed to a DSLAM. A test unit (test head) can then be connected to the line or can interrupt the line by means of a test access matrix in order to make a measurement in the subscriber line and/or the DSL line. For this purpose, the test access matrix normally includes relays or other switching elements. In the event of component failure, however, the printed circuit board on which the test access matrix components are arranged, must be replaced. However, when the printed circuit board is replaced, the connection between the input and output contacts is interrupted, i.e. the subscriber is no longer connected to the network. This problem generally occurs with distributor connection modules when the subscriber lines are connected to the lines of a service unit by means of a printed circuit board.

The invention is based on the technical problem of creating a distributor connection module, which enables the printed circuit board to be changed without interruption.

The solution to the technical problem is given by the subject matter with the characteristics of claim 1. Further advantageous embodiments of the invention can be seen from the dependent claims.

For this purpose, the distributor connection module comprises a housing in which at least one printed circuit board with function elements is arranged, input contacts and output contacts for connecting cores, wherein the input contacts and the output contacts are accessible from the front of the distributor connection module and are or can be electrically connected to one another by means of the printed circuit board, wherein the input and output contacts are arranged on a separate second printed circuit board, wherein the separate second printed circuit board has an interface for connection to the first printed circuit board with the function elements, which interface is designed in the form of a disconnecting plug, wherein electrical connections are fed from the input and output contacts to the disconnecting contacts of the disconnecting plug, wherein one input contact is connected to one output contact in each case when the disconnecting contact is closed and, after plugging onto the first printed circuit board with the function elements, the input and output contacts are connected together via the function elements when the disconnecting contact is open. This enables the second printed circuit board to be replaced without interrupting the service.

Preferably the input contacts and/or the output contacts are designed in the form of at least one printed circuit board plug-in connector, wherein further preferably the input contacts are designed in the form of at least one first printed circuit board plug-in connector and the output contacts are designed in the form of at least one further printed circuit board plug-in connector thus enabling clear disconnection to be achieved. The core connection side of the printed circuit board plug-in connectors is preferably designed with insulation displacement contacts or wire wrap contacts. The connection side to the separate second printed circuit board is preferably designed with bifurcated contacts. In principle, however, the input and output contacts can also be realized using standard plug-in connectors.

In a further preferred embodiment, the function elements are designed in the form of a test access matrix.

In a further preferred embodiment, control contacts for the function elements are arranged on the rear of the housing. By means of these control contacts, function elements can be activated and/or supplied with electrical energy, and/or measurement data can be picked up from the lines.

In a further preferred embodiment, the control contacts are designed in the form of at least one printed circuit board plug-in connector, wherein the printed circuit board plug-in connector is preferably securely connected to the housing in order to simplify the replacement of the first printed circuit board.

In an alternative embodiment, the control contacts are arranged on a backplane, and are connected by means of plug-in contacts to mating contacts on the printed circuit board with the function elements.

In a further preferred embodiment, overvoltage protection elements, in particular gas-filled surge arresters, are arranged on the separate second printed circuit board. These also effectively protect the disconnecting plug against overvoltages. In principle, however, it is also conceivable to arrange the surge arresters on the first printed circuit board with the function elements.

In a further preferred embodiment, the housing is at least partially made of metal, wherein further preferably the separate second printed circuit board is connected to the housing by means of at least one ground contact. At the same time, the housing can also be made completely of metal.

The invention is described in more detail below with reference to a preferred exemplary embodiment. In the drawing:

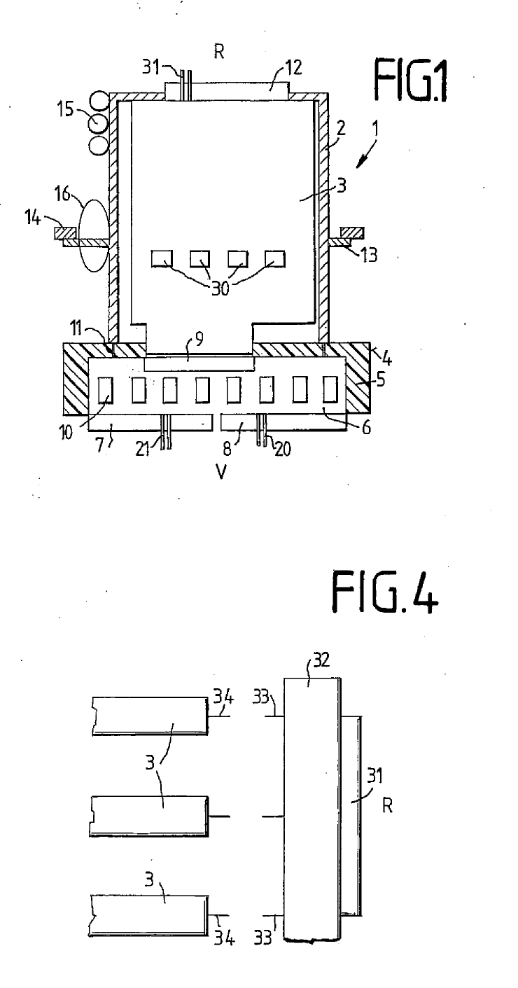

FIG. 1 shows a schematic sectional view through a distributor connection module,

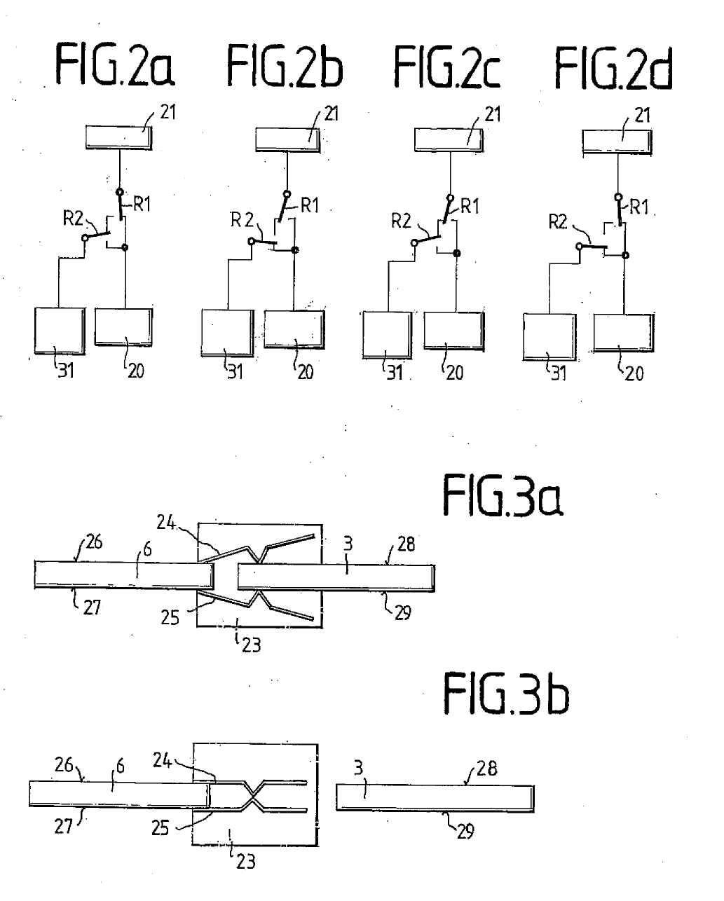

FIG. 2a-d show different switch positions of an element of a test access matrix,

FIG. 3a-b show an open and closed position of a disconnecting contact of a disconnecting plug, and

FIG. 4 shows a schematic representation for the connection of a backplane to the first printed circuit board.

The distributor connection module 1 comprises a housing 2 in which a first printed circuit board 3 with function elements 30 is arranged. Here, it must be noted that the housing 2 usually comprises a plurality of printed circuit boards 3, which are arranged one above the other. Furthermore, the distributor connection module 3 comprises a front section 4, which is arranged on the front V of the distributor connection module 1, for each printed circuit board 3. The front section 4 comprises a housing 5, preferably made of plastic, in which a separate second printed circuit board 6 is arranged. Two printed circuit board plug-in connectors 7, 8 are arranged on the front of the printed circuit board 6. Here, the printed circuit board plug-in connectors 7, 8 are used for connecting double cores, wherein for example DSL lines are connected to the printed circuit board plug-in connector 7 and subscriber lines are connected to the printed circuit board plug-in connector 8. At the same time, contact elements of the printed circuit board plug-in connector 8 form input contacts 20 of the distributor connection module 1, and contact elements of the printed circuit board plug-in connector 7 form output contacts 21 of the distributor connection module 1. Preferably, the printed circuit board plug-in connectors 7, 8 are electrically connected to the printed circuit board 6 by means of bifurcated contacts. On the rear of the printed circuit board 6 is arranged a disconnecting plug 9, which has a number of disconnecting contacts corresponding to the number of contacts for connecting cores of the printed circuit board plug-in connector 7 and 8, and which will be described in more detail below with reference to FIGS. 3a and 3b. At the same time, the disconnecting plug 9 serves as an interface between the second printed circuit board 6 and the first printed circuit board 3. The input contacts 20 and the output contacts 21 are or can be connected to one another via the function elements 30 on the first printed circuit board 3. Furthermore, overvoltage protection elements 10, which protect the disconnecting plug 9 and the function elements 30 on the printed circuit board 3 against overvoltages, are arranged on the second printed circuit board 6. In addition, the printed circuit board 6 has two ground contacts 11, which are electrically connected to the housing 2, which is preferably at least partially made of metal. A ground conductor (not shown) for the surge arresters 10 is connected to the housing chassis or ground via the ground contact 11. On the rear R, the distributor connection module 1 has a plug-in connector 12 with control contacts 31 for control lines (not shown) by means of which the function elements 30 on the printed circuit board 3 are activated and/or supplied with electrical energy, and/or data are picked up. The housing 2 is fixed to slotted mounting rails 14 by means of connecting parts 13, wherein the left-hand and right-hand connecting parts 13 are different. This enables the DSL cable 15 with the appropriate DSL lines to be fed from the rear R via a cable duct 16 between housing 2 and slotted mounting rails 14 to the front V.

Preferred function element 30 of the invention is a test access matrix, which is preferably made up of relays, wherein two relays R1-R2 for example are used for each line. The possible circuits are shown in FIGS. 2a to 2d.

FIG. 2a shows the normal service, wherein the activation circuits for the relays R1-R2 are not shown. The relay R1 is switched in such a way that an electrical connection is made between an input contact 20 for a subscriber line and an output contact 21 for a DSL line, while the relay R2 is switched in such a way that a control contact 31 does not measure a measuring signal.

The relay positions for making a measurement in the subscriber line are shown in FIG. 2b. Relay R1 is switched in such a way that the connection between the contacts 20, 21 is disconnected, while relay R2 is switched in such a way that a test unit (not shown) can make measurements in the subscriber line via the control contact 31.

In FIG. 2c, the relay R2 is now connected to the relay R1, wherein relay R1 is switched in such a way that the contacts 20, 21 are not connected to one another. This enables the test unit to make measurements in the DSL line via the control contact 31.

Finally, a monitoring situation is shown in FIG. 2d in which the relays R1-R2 are switched in such a way that the contacts 20, 21 are connected to one another and the test unit picks up the signals between the contacts 20, 21.

FIGS. 3a and 3b will now be used by way of example to explain the principle of operation of the disconnecting plug 9 (see FIG. 1) on a disconnecting contact 23. The disconnecting contact 23 has two legs 24, 25, which are formed in such a way that they touch one another in the closed state (see FIG. 3b). If, on the other hand, the disconnecting contact 23 is pushed onto the printed circuit board 3, then the two legs 24, 25 are separated and the contact is opened. The leg 24 is connected by means of a printed circuit track (not shown) on the top 26 of the printed circuit board 6 to an input contact 20 of the printed circuit board plug-in connector 8 (subscriber), whereas the leg 25 is connected by means of a printed circuit track (not shown) on the bottom 27 of the printed circuit board 6 to an output contact 21 of the printed circuit board plug-in connector 7 (DSL). In the open state (FIG. 3a), the leg 24 makes contact with a contact pad on a top side 28 of the printed circuit board 6 from where a printed circuit track (not shown) leads to the function element 30. Correspondingly, the leg 25 makes contact with a contact pad on a bottom side 29 of the printed circuit board 6 from where a printed circuit track (not shown) leads to the function element 30.

If a defective printed circuit board 3 is to be replaced, then the printed circuit board 6 with disconnecting plug 9 and printed circuit board plug-in connectors 7, 8 (including the connected subscriber and DSL lines) are removed from the printed circuit board 3 so that the disconnecting contacts 23 close. The input contact 20 is thus connected to the output contact 21 via the overvoltage protection element 10. As a result, the subscriber lines continue to be directly connected to the DSL lines via the overvoltage protection elements 10. The printed circuit board 3 can therefore be replaced without interrupting the service.

FIG. 4 shows schematically how, as an alternative to the plug-in connector 12, the control contacts 31 are connected from the rear R by means of a backplane 32 to the printed circuit boards 3, which are stacked above one another in the housing 2 (see FIG. 1). For this purpose, the backplane 32 has plug-in contacts 33, which can be connected to mating plug-in contacts 34 on the printed circuit boards 3. At the same time, the control contacts 31 can also be designed in the form of multi-pin plug-in connectors.

### LIST OF REFERENCES

1 Distributor connection module
2 Housing
3 First printed circuit board
4 Front section
5 Housing
6 Second printed circuit board
7, 8 Printed circuit board plug-in connector
9 Disconnecting plug
10 Overvoltage protection elements
11 Ground contacts
12 Plug-in connector
13 Connecting parts
14 Slotted mounting rails
15 DSL cable
16 Cable duct
20 Input contact
21 Output contact
23 Disconnecting contact
24, 25 Leg
26 Top of second printed circuit board
27 Bottom of second printed circuit board
28 Top of first printed circuit board
29 Bottom of first printed circuit board
30 Function elements
31 Control contact
32 Backplane
33 Plug-in contact
34 Mating plug-in contact
V Front
R Rear
R1-R2 Relays

1. A distributor connection module comprising:
a housing in which at least one first printed circuit board with function elements is arranged, input contacts and output contacts for connecting cores, wherein the input and output contacts are accessible from the front of the distributor connection module and are or can be electrically connected to one another by the first printed circuit board,
wherein the input and output contacts are arranged on a separate second printed circuit board, wherein the separate second printed circuit board has an interface for connection to the first printed circuit board with the function elements, which interface is designed in the form of a disconnecting plug with disconnecting contacts, wherein electrical connections are fed from the input and output contacts to the disconnecting contacts, wherein one input contact is connected to one output contact in each case when the disconnecting contact is closed and, after plugging onto the first printed circuit board with the function elements, the input and output contacts are or can be connected together via the function elements when the disconnecting contact is open.

2. The distributor connection module as claimed in claim 1, wherein the input and output contacts are designed in the form of at least one printed circuit board plug-in connector.

3. The distributor connection module as claimed in claim 2, wherein the input contacts are designed in the form of a first printed circuit board plug-in connector and the output contacts are designed in the form of a second printed circuit board plug-in connector.

4. The distributor connection module as claimed in claim 1, wherein the function elements are designed in the form of a test access matrix.

5. The distributor connection module as claimed in claim 1, wherein control contacts for the function elements are arranged on the rear of the housing.

6. The distributor connection module as claimed in claim 5, wherein the control contacts are designed in the form of at least one printed circuit board plug-in connector.

7. The distributor connection module as claimed in claim 5, wherein the control contacts are arranged on a backplane, and are connected by plug-in contacts to mating contacts on the printed circuit board with the function elements.

8. The distributor connection module as claimed in claim 1, wherein overvoltage protection elements are arranged on the separate second printed circuit board.

9. The distributor connection module as claimed in claim 1, wherein the housing is at least partially made of metal.

10. The distributor connection module as claimed in claim 9, wherein the separate second printed circuit board is connected to the housing by at least one ground contact.
